(19) United States
(12) Patent Application Publication
(10) Pub. No.: US 2004/0057155 A1
(43) Pub. Date: Mar. 25, 2004

(54) Disk cartridge

(75) Inventor: Harumi Aoishi, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/663,685

(22) Filed: Sep. 17, 2003

(30) Foreign Application Priority Data
Sep. 18, 2002 (JP) 271545/2002

(51) Int. Cl. G11B 23/03

(52) U.S. Cl. 360/133

(57) ABSTRACT

A disk cartridge comprising a disk medium fixedly attached on a center core, a casing with a spindle hole through which the center core is exposed to the exterior, and a dust-removing liner. The center core includes a large-diameter portion, which has an outside diameter greater than the inside diameter of the spindle hole of the casing, a thickness greater than that of the dust-removing liner, and a surface on which said disk medium is fixedly attached.

### BACKGROUND OF THE INVENTION

1. Field of the Invention

The present invention relates to a disk cartridge in which a disk medium is rotatably enclosed within a casing to record or play back information.

2. Description of the Related Art

In conventional magnetic disk cartridges, a magnetic disk medium is constructed of a disk substrate, which is formed from a flexible polyester sheet, etc. This magnetic disk medium has magnetic layers deposited on both sides of the substrate and is rotatably enclosed in a casing. The casing is formed by joining upper and lower shells together, and each shell has a head slot through which a magnetic head is positioned over a recording surface of the magnetic disk medium.

This kind of magnetic disk cartridge is used primarily as a recording medium for computers, because it is easy to handle and low-cost. In this disk cartridge, the lower shell has a spindle hole into which the drive spindle of a disk drive is inserted. A center core is arranged concentrically with the spindle hole and includes a flange portion, which has one surface on which the innermost circumferential portion of the magnetic disk medium is fixedly attached. This kind of center core is disclosed, for example, in Japanese Unexamined Patent Publication No. 2001-325782.

On the other hand, in electronic equipment such as digital still cameras, digital video cameras, laptop personal computers (PCs), etc., a multiplicity of recording media are removably loaded into card slots thereof to record or play back information. These recording media include a semiconductor memory type, a hard-disk type, an optical disk type, and a magnetic disk type (floppy disk type), but a magnetic disk cartridge that is smaller in size and greater in capacity than floppy disks has recently been proposed as a recording medium capable of being loaded in PCs, digital cameras, etc. Such a magnetic recording medium with a high recording density is a magnetic recording medium with a thin metal film formed by vapor deposition, or a magnetic recording medium employing barium ferrite power. An example of the magnetic recording medium employing barium ferrite power is disclosed in Japanese Patent Application No. 2001-312864.

An example of the conventional magnetic disk cartridge is shown in FIGS. 3 and 4. Note in FIG. 4 that parts are shown at ratios differing from the actual dimensions to facilitate the understanding of the magnetic disk cartridge.

This magnetic disk cartridge is equipped with a magnetic disk medium 4, which is rotatably enclosed within a casing C. The casing C is formed by joining upper and lower rectangular shells 1, 2 together. The interior surfaces of the upper and lower shells 1, 2 facing both sides of the magnetic disk medium 4 are provided with upper and lower dust-removing liners 5, respectively.

The outer perimeters of the upper and lower shells 1, 2 are provided with outer perimetrical ribs 1a, 2a forming side walls, and the corners are provided with oblique reinforcement ribs 1b, 2b. The upper and lower shells 1, 2 further have head slots 10 and 11 through which magnetic heads are positioned over both sides of the magnetic disk medium 4.

The magnetic disk medium 4 has an annular recording region 4a between the outermost circumferential portion (non-recording region 4b) and innermost circumferential portion (non-recording region 4b). The innermost circumferential portion of the magnetic disk medium 4 is fixedly attached on a center core 3. A press plate 6 with an annular press portion 6a is fixedly attached on the top surface of the center core 3, and the annular press portion 6a is pressed against the innermost circumferential portion of the magnetic disk medium 4.

The center core 3 is formed, for instance, from a stainless steel (SUS) sheet by sheet pressing or cutting. When the magnetic disk cartridge is inserted in a disk drive, the drive spindle of the disk drive engages the center core 3 and spins the magnetic disk medium 4 at a predetermined speed in the direction of arrow D.

The lower shell 2 has a circular spindle hole 2c through which the center core 3 is exposed to the exterior. That is, the center core 3 is engaged by the drive spindle of the disk drive when the magnetic disk cartridge is loaded in the disk drive. The central portion of the interior surface of the upper shell 1 has an annular protrusion 12, which is fitted in a corresponding groove formed in the press plate 6 to regulate the upward movement of the magnetic disk medium 4.

In the above-described magnetic disk cartridge, incidentally, the inside diameter c of the spindle hole 2c of the lower shell 2 is made greater than the outside diameter a of the center core 3 to assure the engagement stability between the center core 3 and the drive spindle, as shown in FIG. 4. Between the center core 3 and spindle hole 2c, there is provided an annular gap d. Because of this, there is a possibility that dust will enter the interior of the casing C through the annular gap d during storage of the cartridge.

In addition, the magnetic disk medium 4 has flexiblity, so the center core 3 will be in a state in which it hangs by its own weight when the cartridge has been stored. As a result, the magnetic disk medium 4 makes direct contact with the lower dust-removing liner 5 provided on the interior surface of the lower shell 2, and scratches on the magnetic disk medium 4 and sticking between the magnetic disk medium 4 and dust-removing liner 5 will occur due to vibration, shock, and heat. These become a critical problem in the case of higher density recording. Hence, various improvements in the material and properties of the dust-removing liner 5 have been performed, but much effect has not been gained yet and the improvements can be the cause of increased costs.

### SUMMARY OF THE INVENTION

The present invention has been made in view of the circumstances described above. Accordingly, it is the object of the present invention to provide a disk cartridge that is capable of preventing contact between a disk medium and a dust-removing liner even during storage.

To achieve this end and in accordance with the present invention, there is provided a disk cartridge comprising a disk medium, a casing, and a dust-removing liner. The disk medium is fixedly attached on a center core. The casing has a spindle hole through which the center core is exposed to the exterior, and within the case, the disk medium is rotatably enclosed. The dust-removing liner is fixed on the interior surface of the casing. The center core has a large-diameter portion, which has an outside diameter greater than the inside diameter of the spindle hole of the casing, a thickness greater than that of the dust-removing liner, and a disk surface on which the disk medium is fixedly attached.

The expression “large-diameter portion has an outside diameter greater than the inside diameter of the spindle hole of the casing” is intended to mean that the outside diameter of the large-diameter portion is greater to the degree that it does not fall out of the casing through the spindle hole. The outside diameter of a portion of the large-diameter portion may be greater than the spindle hole.

The large-diameter portion has a thickness greater than that of the dust-removing liner. Under this condition, the disk medium can be fixedly attached on the top surface of the large-diameter portion of the center core, and the bottom surface of the large-diameter portion can rest on the interior surface of the casing on which the dust-removing liner is fixedly attached.

According to the disk cartridge of the present invention, the outside diameter of the large-diameter portion of the center core is set greater than the inside diameter of the spindle hole of the casing. Therefore, when the cartridge has been stored, the spindle hole of the casing is hermetically sealed with the large-diameter portion of the center core, and the entry of dust into the casing is prevented. In addition, the thickness of the large-diameter portion of the center core is set greater than that of the dust-removing liner, so non-contact between the recording surface of the disk medium and the dust-removing liner can be maintained during cartridge storage. Thus, damage to the disk medium during conveyance can be lessened. Moreover, because non-contact between the recording surface of the disk medium and the dust-removing liner can be kept, it becomes possible to relax requirements regarding the material, properties, etc., of the dust-removing liner and the cost can also be reduced.

### BRIEF DESCRIPTION OF THE DRAWINGS

The present invention will be described in further detail with reference to the accompanying drawings wherein:

FIG. 1 is a schematic sectional view showing a magnetic disk cartridge constructed in accordance with a preferred embodiment of the present invention, the cartridge being in a state of storage;

FIG. 2 is an explanatory diagram showing the thickness of the large-diameter portion of a center core used in the magnetic disk cartridge in comparison with the thickness of a dust-removing liner;

FIG. 3 is an exploded perspective view showing a conventional magnetic disk cartridge; and

FIG. 4 is a view similar to FIG. 1 showing the conventional magnetic disk cartridge being in a state of storage.

### DESCRIPTION OF THE PREFERRED EMBODIMENT

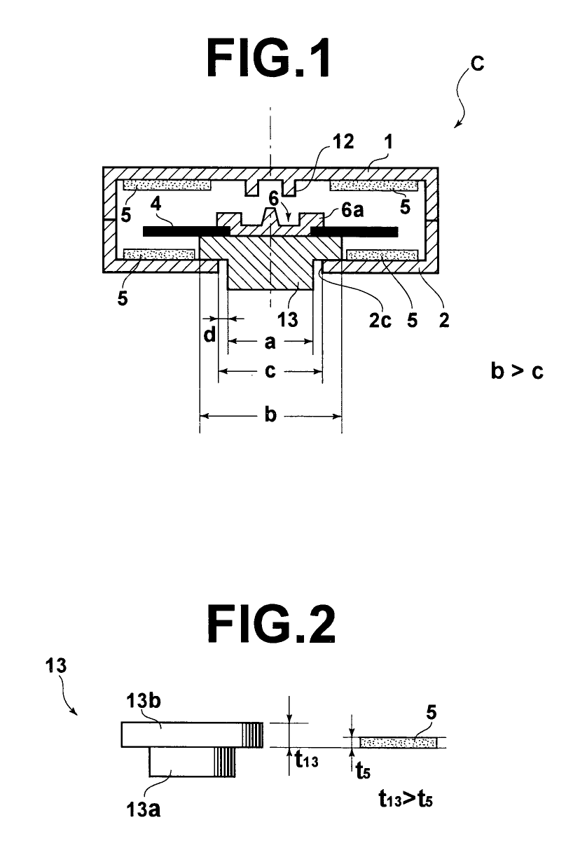

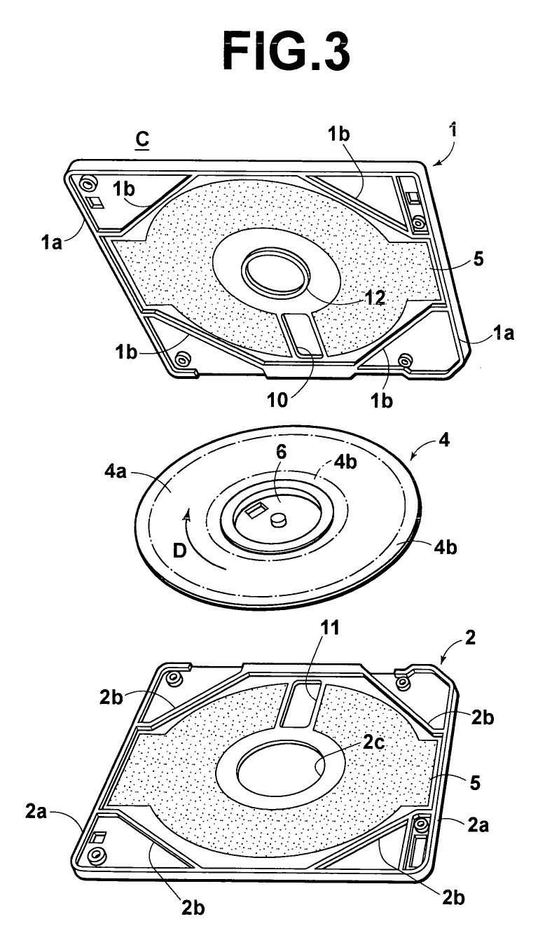

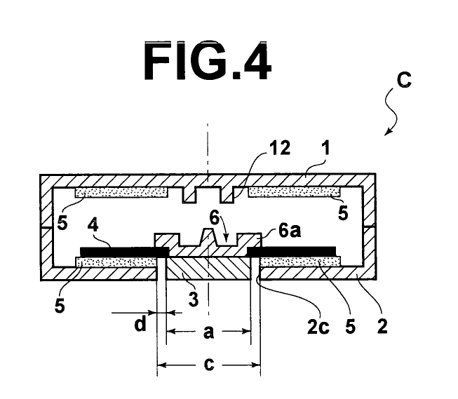

Referring now to FIG. 1, there is shown a magnetic disk cartridge constructed in accordance with a preferred embodiment of the present invention. In the figure, the same reference numerals will be applied to the same parts as FIG. 4 and therefore detailed descriptions of the same parts are omitted to avoid redundancy.

A typical example of this magnetic disk cartridge is a disk cartridge for 3½-inch floppy disks, as with the case of the conventional magnetic disk cartridge shown in FIG. 4. The magnetic disk cartridge is equipped with a flat casing C, a magnetic disk medium 4 rotatably enclosed in the casing C, and a pair of upper and lower dust-removing liners 5 arranged to face both sides of the magnetic disk medium 4. The casing C is formed by joining an upper shell 1 and a lower shell 2 together. The upper and lower shells 1, 2 are formed, for example, from synthetic resin such as an acrylonitrile-butadiene-styrene copolymer.

The magnetic disk medium 4 is constructed of a disk substrate, which is formed from a flexible polyester sheet, etc. This magnetic disk medium 4 has magnetic layers deposited on both sides of the substrate, and the central portion (innermost circumferential portion) is fixedly attached on a center core 13.

The center core 13, as illustrated in FIG. 2, consists of a small-diameter portion 13a, and a large-diameter portion 13b formed integrally with the top of the small-diameter portion 13a. As illustrated in FIG. 1, the magnetic disk medium 4 is fixedly attached on the top surface (i.e., the surface on the side opposite from the side of the small-diameter portion 13a) of the large-diameter portion 13b. The outside diameter b of the large-diameter portion 13b is set greater than the inside diameter c of a spindle hole 2c (b>c), so the circumferential edge portion of the bottom surface of the large-diameter portion 13b rests on the circumferential edge portion of the spindle hole 2c at the time of cartridge storage. That is, the lower dust-removing liner 5, provided on the interior surface of the lower shell 2, needs to be equipped with a center hole, arranged approximately concentrically with the spindle hole 2c, which has an inside diameter greater than the outside diameter b of the large-diameter portion 13b so that it does not contact the large-diameter portion 13b.

The outside diameter a of the small-diameter portion 13a, formed integrally with the bottom surface (i.e., the surface on the side opposite from the disk mounting surface side) of the large-diameter portion 13b of the center core 13, is set smaller than the inside diameter c of the spindle hole 2c (a<c) so that the small-diameter portion 13 is exposed to the exterior through the spindle hole 2c. Thus, there is present an annular gap d between the small-diameter portion 13a and the spindle hole 2c.

The thickness t₁₃ of the large-diameter portion 13b of the center core 13 is set greater than the thickness t₅ of the lower dust-removing liner 5 provided on the interior surface of the lower shell 2. As evident in FIG. 1, when the circumferential edge portion of the bottom surface of the large-diameter portion 13b of the center core 13 rests on the circumferential edge portion of the spindle hole 2c, the magnetic disk medium 4 fixedly attached on the top surface of the large-diameter portion 13b is positioned over the lower dust-removing liner 5. Thus, the contact of the magnetic disk medium 4 with the lower dust-removing liner 5 can be prevented.

It is desirable that the outside diameter b of the large-diameter portion 13b of the center core 13 be about 0.5 to 2 mm greater than the inside diameter c of the spindle hole 2c of the lower shell 2, but considering clearance that is formed when the cartridge is inserted in a disk drive (not shown), it is further preferable that it be 0.5 to 1 mm greater. The thickness t₅ of the lower dust-removing liner 5 is in a range of 0.1 to 0.3 mm, and the thickness t₁₃ of the large-diameter portion 13b of the center core 13 is preferably about 0.5 to 2 mm.

In this case, the bottom surface of the large-diameter portion 13b of the center core 13 is always in contact with the interior surface of the lower shell 2, so there is a possibility that tiny particles will be generated in the contact surface and have influence on recording and playback. In that case, a member with a high sliding property, such as a high polymer PE, may be bonded on the bottom surface of the large-diameter portion 13b of the center core 13, or it may be bonded on the interior surface of the lower shell 2 which contacts the bottom surface of the large-diameter portion 13b of the center core 13, or it may be bonded on both the center core 13 and lower shell 2.

In the preferred embodiment, as described above, the outside diameter b of the large-diameter portion 13b of the center core 13 is set greater than the inside diameter c of the spindle hole 2c of the casing C, and the thickness t₁₃ of the large-diameter portion 13b of the center core 13 is set greater than the thickness t₅ of the lower dust-removing liner 5. Therefore, when the cartridge is stored, the spindle hole 2c of the casing C is hermetically sealed with the large-diameter portion 13b of the center core 13, and the entry of dust into the casing C can be prevented. In addition, during cartridge storage, the recording surfaces of the magnetic disk medium 4 can be held so that they do not contact the dust-removing liners 5. Thus, damage to the magnetic disk medium 4 during conveyance can be lessened.

Moreover, because non-contact between the magnetic disk medium 4 and liners 5 can be maintained, it becomes possible to relax the requirements regarding the material, properties, etc., of the dust-removing liner 5 and the cost can also be reduced.

While the present invention has been described with reference to the preferred embodiment thereof (3½-inch disk cartridge), the invention is not to be limited to the details given herein, but may be modified within the scope of the invention hereinafter claimed. For instance, the invention is also applicable to magnetic disk cartridges in which a smaller magnetic disk medium is enclosed within a casing. Even when the height of the center core is the same, the diameter is smaller and therefore flexure in the smaller disk medium becomes smaller, so that the above-described advantages become greater. Such a magnetic disk cartridge with a small-diameter disk medium is disclosed, for instance, in the aforementioned Japanese Patent Application No. 2002-117838. The present invention is further applicable to disk cartridges with an optical disk such as a DVD-RAM, etc.

What is claimed is:

1. A disk cartridge comprising:
a disk medium fixedly attached on a center core;
a casing, which has a spindle hole through which said center core is exposed to the exterior, and in which said disk medium is rotatably enclosed; and
a dust-removing liner fixed on an interior surface of said casing;
wherein said center core comprises
a large-diameter portion that has an outside diameter greater than the inside diameter of the spindle hole of said casing, a thickness greater than that of said dust-removing liner, and a disk surface on which said disk medium is fixedly attached.

2. The disk cartridge as set forth in claim 1, wherein said disk medium comprises a magnetic disk medium.

3. A disk cartridge comprising:
a disk medium fixedly attached on a center core;
a casing, which has a spindle hole through which said center core is exposed to the exterior, and in which said disk medium is rotatably enclosed; and
a dust-removing liner fixed on an interior surface of said casing;
wherein said center core comprises
a large-diameter portion that has an outside diameter greater than the inside diameter of the spindle hole of said casing, a thickness greater than that of said dust-removing liner, and a disk surface on which said disk medium is fixedly attached; and
a small-diameter portion which has an outside diameter smaller than the inside diameter of the spindle hole of said casing, and which is formed on a side, opposite from said disk surface, of said large-diameter portion so that it is exposed to the exterior through the spindle hole of said casing.

4. The disk cartridge as set forth in claim 3, wherein said disk medium comprises a magnetic disk medium.

5. The disk cartridge as set forth in claim 3, wherein said dust-removing liner has a center hole, arranged approximately concentrically with the spindle hole of said casing, which has an insider diameter greater than the outside diameter of the large-diameter portion of said center core.
